(19) United States
(12) Patent Application Publication
(10) Pub. No.: US 2024/0026238 A1
(43) Pub. Date: Jan. 25, 2024

(54) PROCESS FOR PREPARING BIODIESEL (METHYL ESTER)

(71) Applicant: Mohammed Idris AHMED, Telangana (IN)

(72) Inventor: Mohammed Idris AHMED, Telangana (IN)

(21) Appl. No.: 17/894,476

(22) Filed: Aug. 24, 2022

(30) Foreign Application Priority Data
Jul. 23, 2022 (IN) 20224102315

(51) Int. Cl. C10L 1/02

(52) U.S. Cl. CPC C10L 1/026; C10L 2200/0476; C10L 2200/0484; C10L 2290/547; C10L 2200/029

(57) ABSTRACT

The present invention discloses a method for preparing biodiesel (Methyl Ester) from any kind of oil, vegetable or non-vegetable oil or used cooking oil. Further, it relates to a method for preparing biodiesel (Methyl Ester) with 100% purity which can be directly used as a fuel in cars, trucks, buses industrial and domestic purpose without any need to blend with any petroleum diesel. The present invention also discloses the biodiesel having improved cold flow properties, flash point and 57 cetane number with reduced exhaust emission where CO₂ emits approx. 2.96% v/v and CO emits approx. 0.2 ppm % v/v.

### CROSS REFERENCE TO RELATED APPLICATION

The present application claims the benefit and takes priority from Indian Patent Application No. 202241042315 filed on Jul. 23, 2022, the contents of which are herein incorporated by reference.

### FIELD OF INVENTION

The present invention relates to a method for preparing biodiesel (Methyl Ester) from vegetable oils and animal fats.

More particularly, it relates to transesterification processes useful for producing biodiesel (Methyl Ester) from vegetable oils and animal fats.

More particularly, it relates to a method for preparing high quality with 100% purity biodiesel (Methyl Ester) which minimize the exhaust emission from vehicle.

### BACKGROUND AND PRIOR ART OF THE INVENTION

“Biodiesel” typically refers to a diesel-equivalent, processed fuel derived from biological sources. Biodiesel is a renewable fuel crafted from vegetable oils and animal fats. Compared with fossil fuels, it has the capability to relieve environmental pressures and gain sustainable development.

The biodiesel is derived from renewable biomass resources, as a result now no longer containing the materials inclusive of sulfur and hydrocarbon, etc. normally located with inside the fossil diesel. The biodiesel has a brief carbon chain, carries oxygen itself and may be absolutely combusted, in order now no longer to supply atmospheric pollution inclusive of So, aromatic hydrocarbon, polycyclic aromatic hydrocarbon, etc., averagely lessen waste fuel line with the aid of using above 45%, and successfully lessen the threat of tail fueloline to the environment. The use of biodiesel can successfully lessen the concentrations of CO and TPM in tail fueloline, and the contribution of the biodiesel to inexperienced residence impact is most effective 25% or decrease of that of fossil diesel. Moreover, the biodiesel additionally has wonderful biodegradability in comparison with fossil diesel. The biodiesel has right environmental safety performance. The quantity of sulfur dioxide and sulfide emitted with the aid of using the biodiesel upon combustion is decreased with the aid of using approximately 30% in comparison to not unusual place diesel. The biodiesel has oxygen content material as much as 11%, and right ignition performance, in order that the damaging materials inclusive of HC, CO, etc. discharged in the course of combustion are substantially decreased in comparison to not unusual place diesel. The materials discharged with the aid of using the biodiesel upon combustion include no dangerous materials inclusive of sulfur dioxide, lead, halogen, etc., which could be very favorable to environmental safety. Hence, the biodiesel is renewable environmentally-pleasant fuel, and has right application prospect.

Although raw vegetable oils may be used as fuels for certain compression ignition internal combustion engines, biodiesel generally refers to oil which has been processed to provide a clean-burning alternative fuel, produced from domestic, renewable resources. Biodiesel can be used on its own or blended in any proportions with petroleum diesel to create a biodiesel blend. Biodiesel, or blends thereof, may be used be used in diesel engines with little or no engine modification. Biodiesel is biodegradable, non-toxic, and has very low levels of sulfur and harmful aromatic compounds. In other words it is a clean and environmentally friendly fuel.

Already, vehicular emission is a major cause of air pollution in urban areas. Typically, vehicular emission contributes 20-30 percent of particulate matter 2.5 (particles of size less than or equal to 2.5 micrometres) at the breathing level of air quality. This is considered more toxic because of the toxic constituents of its PM2.5 emissions.

Exhaust gas or flue gas is emitted as a result of the combustion of fuels such as natural gas, gasoline (petrol), diesel fuel, fuel oil, biodiesel blends,^{[1]} or coal. According to the type of engine, it is discharged into the atmosphere through an exhaust pipe, flue gas stack, or propelling nozzle. It often disperses downwind in a pattern called an exhaust plume.

It is a major component of motor vehicle emissions (and from stationary internal combustion engines), which can also include crankcase blow-by and evaporation of unused gasoline.

Motor vehicle emissions contribute to air pollution and are a major ingredient in the creation of smog in some large cities. A 2013 study by the Massachusetts Institute of Technology (MIT) indicates that 53,000 early deaths occur per year in the United States alone because of vehicle emissions. According to another study from the same university, traffic fumes alone cause the death of 5,000 people every year just in the United Kingdom.

According to studies, vehicles annually contribute about 290 gigagrams (Gg) of PM2.5. At the same time, around eight percent of total greenhouse gas (GHG) emissions in India are from the transport sector, and in Delhi, it exceeds 30 percent.

Most countries have formulated regulations for testing vehicles at the manufacturing end and when in use. The vehicle certification procedures consist of testing engine performance and emission compliance on the engine chassis dynamometer in the laboratory.

The largest part of most combustion gas is nitrogen (N₂), water vapor (H₂O) (except with pure-carbon fuels), and carbon dioxide (CO₂) (except for fuels without carbon); these are not toxic or noxious (although water vapor and carbon dioxide are greenhouse gases that contribute to climate change). A relatively small part of combustion gas is undesirable, noxious, or toxic substances, such as carbon monoxide (CO) from incomplete combustion, hydrocarbons (properly indicated as CₓH_{y}, but typically shown simply as “HC” on emissions-test slips) from unburnt fuel, nitrogen oxides (NOₓ) from excessive combustion temperatures, and particulate matter.

In spark-ignition engines the gases resulting from combustion of the fuel and air mix are called exhaust gases. The composition varies from petrol to diesel engines, but is around these levels:

| Combustion-engine exhaust gases | | | % of total |
|---|---|---|---|
| | Compound | Petrol | Diesel |
| | nitrogen | 71 | 67 |
| | carbon dioxide | 14 | 12 |
| | water vapor | 13 | 11 |
| | oxygen | | 10 |
| | Trace elements | <0.6 | ~0.3 |
| | nitrogen oxides | <0.25 | <0.15 |
| | carbon monoxide | 1-2 | <0.045 |
| | particulate matter | | <0.045 |
| | hydrocarbons | <0.25 | <0.03 |
| | sulfur dioxide | possible traces | <0.03 |

The carbon footprint is one of the ways we measure the effects of human-induced global climate change. It primarily focuses on the greenhouse gas emissions associated with consumption, but also includes other emissions such as methane, nitrous oxide, and chlorofluorocarbons.

Carbon footprint: the amount of greenhouse gases and specifically carbon dioxide emitted by something (such as a person's activities or a product's manufacture and transport) during a given period.

Pollutants produced by vehicle exhausts include carbon monoxide, hydrocarbons, nitrogen oxides, particles, volatile organic compounds and sulfur dioxide. Hydrocarbons and nitrogen oxides react with sunlight and warm temperatures to form ground-level ozone. Ground-level ozone, a main ingredient in smog, can cause upper respiratory problems and lung damage.

Research shows that motor vehicles are responsible for about 70%. use and motor vehicle pollution Unless we all start reducing car, this level is set to increase dramatically.

Studies shows that selection of fuel is one of the major factor in emitting gases from vehicle. It is a known fact now that the production and use of biodiesel are an essential part of the slowing the rate of climate change policy and allow both greenhouse gas emissions and other emission performance of engines and combustion plants to be reduced, as well as to reduce the dependency on oil exporting countries in the economic activity of the state.

However, most of the time biodiesel is blending with other fuels to yield cold flow properties and used in the vehicle for Production of other renewable fuels is significantly lower than biodiesel production and biodiesel will remain dominant in the near future, therefore improvement of the biodiesel production process is of great importance.

Blending biodiesel with Petro diesel may be advantageous for mitigating the poor cold flow properties of biodiesel from many lipid feedstocks. On the other hand, blending at higher ratios may compromise cold flow properties, however it is not cost effective as well as produces high exhaust emitting gases as compared to when biodiesel used alone.

Referring to Applicant's own granted Indian Patent Application No. 201641014608 which discloses a method for preparing biodiesel (Methyl Ester) from animal tallow oil with 100% purity which can be directly used as a fuel in cars, trucks, buses industrial & domestic purpose without any need to blend with any petroleum diesel and having improved cold flow properties, flash point and 55 cetane number.

In Patent Application No. 201641014608, the main objective was to reduce the costing of biodiesel and to improve the cold flow properties, accordingly animal tallow oil was used, however since animal tallow oil is not acceptable in many countries including India, inventor soon realize the need of alternative of raw material to produce 100% pure cost-effective biodiesel which enhanced its properties which minimize the exhaust emission from the vehicle. Accordingly, the present invention provides a method for preparing biodiesel (Methyl Ester) from any of the vegetable or non vegetable oils such as Soya Fatty Oil, Palm Fatty Oil, Palm Stearin, Used Cooking Oil, Jatropha Oil, Tallow and Sunflower Fatty Oil etc.,

Presently, one technique for producing biodiesel is based on trans-esterifying vegetable oils (e.g., soybean oil, rapeseed oil, and corn oil) or animal fats (e.g., tallow) in the presence of a catalyst to produce alkyl esters. The transesterification process can also produce glycerol, fatty acid, soap, and/or other undesirable contaminants. Even though the target specification for biodiesel varies from country to country, the total glycerol content in biodiesel is typically limited to about 0.25 to about 0.38 weight percent (wt. %) or less.

Such a low glycerol requirement normally requires a two-step addition of the catalyst during the transesterification process. However, even with the two-step addition of the catalyst, it can still be difficult to meet the glycerol requirement when fats with high acid values, methanol with high moisture, and/or other low-quality feedstock is used. For example, most commercial biodiesel production typically requires vegetable oil feedstock with acid values of 3 or less, preferably 1 or less. Accordingly, there is a need for a more efficient and cost-effective technique for trans-esterifying triglyceride-containing fats to produce biodiesel or other alkyl esters.

There are various Patents references which discloses process of biodiesel from the extracted oil of such plants are corn, sunflower, olive, soybeans, rapeseed, wheat, sugar beet, sugar cane, jatropha, palm, sorghum, cassava, hemp, algae and the like. Dried or partially dried biomasses of such plants which contain the oily glycerides necessary for the direct conversion of biodiesel. Such plants also include those described in U.S. Pat. Nos. 5,525,126; 6,855,838; and 6,965,044 and U.S. Patent Application Publication Nos. 2007/0048848; and 2003/0158074. However, the biodiesel obtained from these processes either not 100% pure or not controlling to the exhaust emissions beyond the certain limit.

Chinese patent application CN 101906355A discloses a method for preparing biodiesel by utilizing food waste recycling oil. The method comprises pre-treating dining waste recycled oil using 1.5 wt. % of 98% concentrated sulfuric acid, then esterifying the pre-treated dining waste recycled oil using 5 wt. % of concentrated sulfuric acid based on the weight of raw material under the temperature of 65° C. for 2 h, transferring into an acid-catalyzed settlement separator, performing ester exchange using 1 wt. % of 95% solid sodium hydroxide based on the weight of raw material under the temperature of 65° C. for 30 min, separating crude biodiesel through an alkali-catalyzed settlement separator, washing the obtained crude biodiesel with 3% of 98% concentrated sulfuric acid based on the volume of the crude biodiesel in a water-washing neutralization tower, then washing with water, and heating to distill the upper-layer biodiesel to obtain the final product. The method performs esterification reaction and ester exchange reaction in different reaction kettles respectively, and separates intermediate products through two settlement separators, thus increasing equipment cost and energy consumption. The method requires water-washing neutralization after ester exchange. The total amount of added concentrated sulfuric acid reaches 9.5% of raw material, so as to produce a large amount of acid water during water washing process, thus a large amount of alkali is required for neutralization in latter sewage treatment, thereby increasing treatment cost.

On the other hand, there exists some problems while independently using sodium hydroxide as catalyst in practical application: 1. long dissolving time and low dissolution rate of sodium hydroxide and methanol; 2. incomplete ester exchange reaction; 3. easy agglomeration of sodium salt, which results in serious pipeline blocking during ester exchange reaction when using soybean acid oil as raw material, thus not widely suitable for various raw materials; and 4. low separation speed of glycerol and fatty acid methyl ester produced in the reaction.

Reference may be made from Patent Application WO 2008093990 which discloses a method of producing biodiesel having good low-temperature fluidity from palm oil. Palm biodiesel (or palm fatty acid) obtained from palm oil is separated into C16 palm biodiesel (or C16 palm fatty acid) and C18 palm biodiesel (or C18 palm fatty acid) through distillation and the C16 palm biodiesel (or C16 palm fatty acid) fraction poor in low-temperature fluidity is converted into C15/C16 paraffins through hydrotreating.

However, the present invention's approach, scope, method and system is completely different from the cited art.

The present invention uses vegetable and animal oil for production of biodiesel which is most advantageous in terms of production cost, controlling in exhaust emission from vehicle.

Further, reference may be made in EP Patent No. EP 2684938 A2 which relates to a method for manufacturing biodiesel by isomerizing a part of the resultant of hydro deoxygenation and recycling the isomerized product, and then hydro deoxygenating a fresh feed in a diluted state again when oxygen is removed in the form of water, CO, and CO₂ by adding hydrogen to a feed including triglyceride (TG).

Moreover, this invention relates to a method of manufacturing paraffin-based biodiesel having improved cold flow properties from a feed containing triglyceride, wherein multi-step hydrodeoxygenation is performed using a fresh feed in a diluted state after isomerizing part of the product of hydrodeoxygenation and then recycling the isomerized product. However, the present invention's approach, scope, method and system is completely different from this invention

The major shortcomings of the prior art inventions are that the obtained biodiesel are either used to blend with petroleum diesel or not capable to control exhaust emission beyond certain limit.

Against this background, present invention focuses on the high quality biodiesel with the improved quality of controlling exhaust emission in a better way without blended with any other petroleum diesel.

The invention can save millions of dollars as the raw material used in the present invention is very cheap and readily available.

### Object of the Invention

The main object of the present invention is to provide a method of producing biodiesel (Methyl Ester) having better control on exhaust emission in vehicle.

The main object of the present invention is to provide a method of producing biodiesel (Methyl Ester) having better exhaust emission in vehicle where raw material is any kind of vegetable and animal oil and even used oil.

It is another object of the present invention to provide a method for preparing high quality with 100% purity biodiesel (Methyl Ester) which can be directly used as a fuel in cars, trucks, buses, industrial & domestic purpose.

It is yet another object of the present invention to provide a biodiesel (Methyl Ester) which can be directly used as a fuel in cars, trucks, buses, industrial & domestic purpose.

It is yet another object of the present invention to provide a biodiesel (Methyl Ester) which reduces the exhaust emission components.

It is yet another object of the present invention to provide a cost-effective biodiesel (Methyl Ester).

It is yet another object of the present invention to provide high quality biodiesel (Methyl Ester) which can be directly used as a fuel without any need to mix it up with other petroleum diesel.

### SUMMARY OF THE INVENTION

The present invention provides a method for preparing biodiesel (Methyl Ester) from vegetable or animal oil and combination thereof.

More particularly, the present invention relates to a method for preparing biodiesel (Methyl Ester) with 100% purity which can be directly used as a fuel in cars, trucks, buses, industrial & domestic purpose without any need to blend with any petroleum diesel and reduces the exhaust emission from the vehicle

The present invention also discloses the biodiesel having improved cold flow property and simultaneously control on exhaust emission where CO₂ emits approx. 2.96% v/v and CO emits approx. 0.2 ppm % v/v.

### BRIEF DESCRIPTION OF THE DRAWINGS

Embodiments of the present invention will hereinafter be described in conjunction with the following drawings, wherein:

FIG. 1 schematically illustrates a system for production of biodiesel (Methyl Ester) in accordance with an exemplary embodiment.

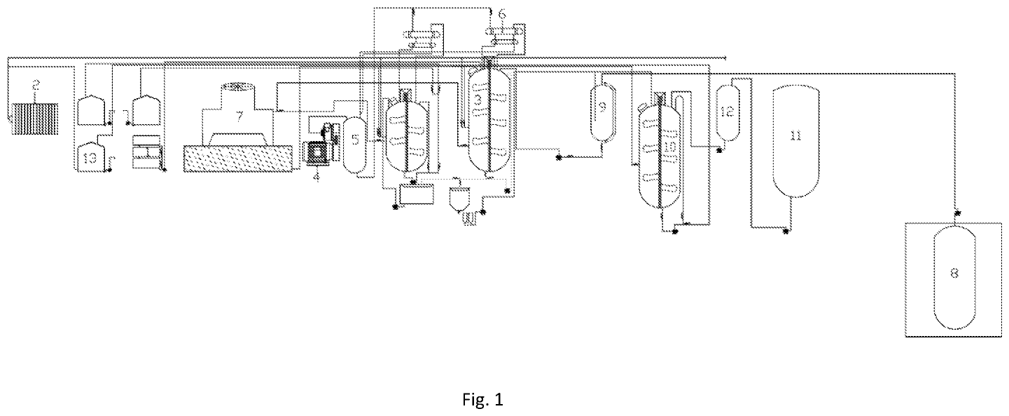

The above summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Accordingly, the present invention provides a method for preparing biodiesel (Methyl Ester) from vegetable or non-vegetable oil and/or its combination thereof, wherein the said method comprising the steps of:
a) discharging oil as a raw from the storage tank (1) in the reactor (3) followed by discharging the steam from the boiler (2) in the reactor (3) at the temperature of 30 to 110 Degrees;
b) discharging vacuum from the-pump (4) to receiver tank (5) and then through condenser (6) to the reactor (3), at the pressure in the range of 150 to 750 mg/kg for about 0 to 3 Hours;
Wherein the moisture contents (MC) is obtained less than 0.01 to 0.05%, after processing, steering in the reactor (3) at the rpm of 60 to 75 followed by circulation of oil Through Pump about 0-2.5 hours followed by cooling from the cooling tower (7) in the reactor to reduce the temperature from about 110 to about 70 Degrees;
C) conducting-transesterification step in three phases:

### Phase 1:

(i) discharging 10-16 wt. % methanol of total weight of oil in the reactor (3) from—the underground storage tank (8)—to the chemical receiver tank (9) wherein the exact quantity and accuracy of methanol is maintained by the Level Indicator in chemical receiver tank (9);
(ii) adding 0.7-1.5% Potassium Hydroxide Pellets (Koh) or 1-4% Sodium Methoxide (CH3NaO) in the chemical receiver tank (9) and dissolving it completely in chemical receiver tank (9), followed by circulating it for about 0-60 minutes, and then discharging to the reactor (3); wherein phase 1 Continues the process for about 0-4 hours and maintained the temp. at 80 to 70 degree centigrade;
(iii) settling the mixture of reactor (3) for 0-60 minutes, prior to separating glycerin, wherein glycerin is separated via gravity, so as to obtain a biodiesel (methyl ester) approximately with 70% of purity;

### Phase II:

(i) discharging 3-6 wt. % of methanol of total weight of oil from the underground storage tank (8) to the chemical receiver tank (9) wherein the exact quantity and accuracy of methanol is maintained by the Level Indicator in chemical receiver tank (9);
(ii) adding 0.1-0.5% Potassium Hydroxide Pellets (Koh) or 0.1-1% Sodium Methoxide (CH3NaO) in the chemical receiver tank (9) and dissolving it completely in chemical receiver tank (9), followed by circulating it for about 0-60 minutes, and then discharging to the reactor (3); where the processed oil of phase I is present; wherein phase 1 Continues the process for about 0-4 hours and maintained the temp. at 80 to 70 degree centigrade;
(iii) settling the mixture of reactor (3) for 0-60 minutes, prior to separating glycerin, wherein glycerin is separated via gravity;
(iv) adding 0.1-0.8% Food Grade Phosphoric Acid (concentrated 80-99%) on Total wt., where the processed oil of phase II is present in reactor (3) followed by steering and circulating it for about 0-120 minutes;
(v) settling the mixture of reactor (3) for 0-60 minutes, prior to separating Soap oil, wherein so as to obtain a biodiesel (methyl ester) approximately with 100% of purity with no residue of glycerin and soap.

### Phase III:

(i) adding light liquid paraffin (LLP) in the range of 1-25 wt. % of total weight of biodiesel (methyl ester) of phase II, from the receiver tank (11) to the chemical receiver tank (12) and then to the reactor (10);
(ii) adding TBHQ (TERT BUTYL HYDROQUINONE) in the range of 0.1% to 0.5% of total weight of biodiesel (methyl ester) of phase II, to the reactor (10), where the processed oil of phase III (i) is present followed by steering in the reactor (10) at the rpm of 60 to 70 and circulating for about 0-120 minutes, wherein the phase III (i & ii) Continues the process for about 0-2 hours while maintaining the Temp. at 70 to about 65 Degrees;
(iii) shifting the biodiesel (methyl ester) of phase II from reactor (3) to reactor (10); where the processed oil of phase III (I & ii) is present followed by steering in the reactor (10) at the rpm of 60 to 70 and circulating for about 0-120 minutes.
(iv) draining the biodiesel (Methyl Ester) from reactor (10) to leaf filter, wherein filter mesh is 1-3 microns, followed by discharging the filtered biodiesel B100 into storage tank (13) with 100% purity.

In an embodiment of the present invention, the vegetable oil is selected from the group comprising Soya oil, Palm oil, Palm Stearin, Used Cooking Oil, Jatropha oil, Tallow and Sunflower oil etc.

In another embodiment of the present invention, the weight ratio of methanol to the oil in the phase I is approximately 1:0.10-1:0.16.

In yet another embodiment of the present invention, the weight ratio of methanol to the oil in the phase II is in the range of 1:0.03-1:0.06.

In still another embodiment of the present invention, the weight ratio of Potassium Hydroxide to the oil in the phase I is approximately 1:0.007-1:0.015.

In still another embodiment of the present invention, the weight ratio of Sodium Methoxide to the oil in the phase I is approximately 1:0.01-1:0.04.

In still another embodiment of the present invention, the weight ratio of Potassium Hydroxide to the oil in the phase II is in the range of 1:0.001-1:0.005.

In still another embodiment of the present invention, the weight ratio of Sodium Methoxide to the oil in the phase II is in the range of 1:0.001-1:0.01.

In still another embodiment of the present invention, the weight ratio of Light Liquid paraffin oil to the biodiesel (methyl ester) of phase III is in the range of 1:0.01-1:0.25.

In still another embodiment of the present invention, the weight ratio of TERT BUTYL HYDROQUINONE to the biodiesel (methyl ester) of phase III is in the range of 1:0.001-1:0.005.

The ensuing description provides the methods and product only, and is not intended to limit the scope, applicability, or configuration of the claims. Rather, the ensuing description will provide those skilled in the art with an enabling description for implementing the embodiments. It is being understood that various changes may be made in the process in terms of conditions towards temperature, pressure etc. without departing from the scope of the appended claims.

The following examples are given by way of illustration of the present invention and should not be construed to limit the scope of present invention.

### Example—1

Phase I, II & III experiments are performed in the following manners.
A. discharging used cooking oil at room temperature as a raw from the storage tank (1) in the reactor (3); Discharge the steam from the boiler (2) in the reactor (3) at the temperature up 15 to 150 Degrees.
B. vacuum discharge from the-pump (4) to receiver tank (5), from receiver tank (5) Through condenser (6) to the reactor (3), Vacuum at the pressure in the range of up to 750 mg/kg up to 4 Hours.
C. Wherein the moisture contents (MC) is obtained less than 0.01%, after processing, steering in the reactor (3) at the rpm up to 75 followed by circulation of oil through pump up to 2.5 hours followed by cooling from the cooling tower (7) in the reactor to reduce the temperature from 150 to 100 Degrees.
D. conducting-transesterification step in three phases:

### Phase 1:

1. a—discharging 18 wt. % methanol of total weight of oil in the reactor (3) from—the underground storage tank (8)—to the chemical receiver tank (9) wherein the exact quantity and accuracy of methanol is maintained by the Level Indicator in chemical receiver tank (9).
2. Adding 2.5 wt. % Potassium Hydroxide Pellets (Koh) in the chemical receiver tank (9) And completely dissolve in chemical receiver tank (9), followed by circulation, Duration for 60 minutes, then discharge—to the reactor (3). Phase 1 Continued the process for 4 hours and maintained Temp. at 150 degrees.
   Settling—Shut down the power and settling up to 60 minutes, Prior to separating glycerin, separating glycerin via gravity, so as to obtain a biodiesel (methyl ester) approximately with 70% of purity;

### Phase II:

1. discharging 6 wt. % methanol of total weight of oil in the reactor (3) from the underground storage tank (8) to the chemical receiver tank (9) wherein the exact quantity and accuracy of methanol is maintained by the Level Indicator in chemical receiver tank (9).
2. Adding 1.5% Potassium Hydroxide Pellets (Koh) in the chemical receiver tank (9) And completely dissolve in chemical receiver tank (9), followed by circulation, Duration about up to 60 minutes, then discharge to the reactor (3) where the processed oil of phase I is present;
   Phase II Continued the process up to 3 hours and maintained Temp. at 150 degrees.
   Settling—Shut down the power and settling for 60 minutes, prior to separating glycerin, separating glycerin via gravity, After Glycerin Separated,
   Adding (Food Grade Phosphoric Acid concentrated 80-99%), 0.03% on Total wt., where the processed oil of phase II is present in reactor (3); steering and circulation for 120 minutes. After completing of 120 minutes.
   settling—Shut down the power and settling for 60 minutes, prior to separating Soap Oil. so as to obtain a biodiesel (methyl ester and glycerin and soap being separated out;

### Phase III:

A—Adding light liquid paraffin 5 wt. % of total weight of biodiesel (methyl ester) of phase II, from the receiver tank (11) to the chemical receiver tank (12) and then to the reactor (10).
B—Adding TBHQ (TERT BUTYL HYDROQUINONE) 0.02% of total weight of biodiesel (methyl ester) of phase II, to the reactor (10), where the processed oil of phase III (A) is present, steering in the reactor (10) at the rpm of 70 followed by circulation of 120 minutes.
Phase III (A&B) Continued the process for 2 hours and maintained Temp. at 100 Degrees. After complete the process A&B shifting the biodiesel (methyl ester) of phase II from reactor (3) to reactor (10); where the processed oil of phase III (A&B) is present, steering in the reactor (10) at the rpm of 70 followed by circulation of 120 minutes.
Process is completed.

Conclusion: We could not obtain biodiesel with 100% purity

### Example—2

Phase I, II & III experiments are performed in the following manners.
A. Heating Palm stearin at the temperature of 90 deg, to form a liquid.
B. discharging oil as a raw from the storage tank (1) in the reactor (3); Discharge the steam from the boiler (2) in the reactor (3) at the temperature of 130 Degrees.
C. vacuum discharge from the-pump (4) to receiver tank (5), from receiver tank (5) Through condenser (6) to the reactor (3), vacuum at the pressure of 750 mg/kg for 4 Hours.
D. Wherein the moisture contents (MC) is obtained less than 0.05%, after processing, steering in the reactor (3) at the rpm of 75 followed by circulation of oil through Pump for 2.5 hours followed by cooling from the cooling tower (7) in the reactor to reduce the temperature from 130 to 90 Degrees.
E. conducting-transesterification step in three phases:

### Phase 1:

1. a—discharging 17 wt % methanol of total weight of oil in the reactor (3) from—the underground storage tank (8)—to the chemical receiver tank (9) wherein the exact quantity and accuracy of methanol is maintained by the Level Indicator in chemical receiver tank (9).
2. Adding 4% Sodium Methoxide (CH3NaO), in the chemical receiver tank (9) and completely dissolve in chemical receiver tank (9), followed by circulation, Duration for 60 minutes, then discharge—to the reactor (3). Phase 1 Continued the process for 4 hours and maintained Temp. at 130
3.
   Settling—Shut down the power and settling for 60 minutes, Prior to separating glycerin, separating glycerin via gravity, so as to obtain a biodiesel (methyl ester) approximately with 70% of purity;

### Phase II:

a—discharging 5 wt. % methanol of total weight of oil in the reactor (3) from the underground storage tank (8) to the chemical receiver tank (9) wherein the exact quantity and accuracy of methanol is maintained by the Level Indicator in chemical receiver tank (9).
Adding 2% Sodium Methoxide (CH3NaO) in the chemical receiver tank (9) And completely dissolve in chemical receiver tank (9), followed by circulation, Duration for 60 minutes, then discharge to the reactor (3) where the processed oil of phase I is present;
Phase II Continued the process for a hours and maintained Temp. at 130 degree.
Settling—Shut down the power and settling for 60 minutes, prior to separating glycerin, separating glycerin via gravity, After Glycerin Separated,
Adding (Food Grade Phosphoric Acid concentrated 80-99%), 0.4% on total wt., where the processed oil of phase II is present in reactor (3); steering and circulation 120 minutes. After completing of 120 minutes.
settling—Shut down the power and settling 60 minutes, prior to separating Soap Oil. so as to obtain a biodiesel (methyl ester) and glycerin and soap being separated out;

### Phase III:

A—Adding light liquid paraffin 10 wt. % of total weight of biodiesel (methyl ester) of phase II, from the receiver tank (11) to the chemical receiver tank (12) and then to the reactor (10).
B—Adding TBHQ (TERT BUTYL HYDROQUINONE) 0.1% of total weight of biodiesel (methyl ester) of phase II, to the reactor (10), where the processed oil of phase III (A) is present, steering in the reactor (10) at the rpm of 70 followed by circulation for 120 minutes.
Phase III (A&B) Continued the process for 2 hours and maintained Temp. at 90 Degrees. After complete the process A&B shifting the biodiesel (methyl ester) of phase II from reactor (3) to reactor (10); where the processed oil of phase III (A&B) is present, steering in the reactor (10) at the rpm of 70 followed by circulation for 120 minutes.
Process is completed.

Conclusion: Result is failed, we could not obtain biodiesel with 100% purity

### Example—3

Phase I, II & III experiments are performed in the following manners.
A. Heating Tallow oil (animal oil) at the temperature of 90 deg, to form a liquid.
B. discharging oil as a raw from the storage tank (1) in the reactor (3); Discharge the steam from the boiler (2) in the reactor (3) at the temperature of 120 Degrees.
C. vacuum discharge from the-pump (4) to receiver tank (5), from receiver tank (5) Through condenser (6) to the reactor (3), Vacuum at the pressure at 750 mg/kg for 4 Hours.
D. Wherein the moisture contents (MC) is obtained less than 0.05%, after processing, steering in the reactor (3) at the rpm 75 followed by circulation of oil through Pump for 2.5 hours followed by cooling from the cooling tower (7) in the reactor to reduce the temperature from 120 to 90 Degrees.
E. conducting-transesterification step in three phases:

### Phase 1:

1. discharging 16th % methanol of total weight of oil in the reactor (3) from—the underground storage tank (8) to the chemical receiver tank (9) wherein the exact quantity and accuracy of methanol is maintained by the Level Indicator in chemical receiver tank (9).
2. Adding 1.5% Potassium Hydroxide Pellets (Kohin the chemical receiver tank (9) And completely dissolve in chemical receiver tank (9), followed by circulation, Duration for 60 minutes, then discharge—to the reactor (3). Phase 1 Continued the process for 4 hours and maintained Temp. at 120 degree.
   Settling—Shut down the power and settling for 60 minutes, Prior to separating glycerin, separating glycerin via gravity, so as to obtain a biodiesel (methyl ester) approximately with 70% of purity;

### Phase II:

1. discharging 4 wt. % methanol of total weight of oil in the reactor (3) from the underground storage tank (8) to the chemical receiver tank (9) wherein the exact quantity and accuracy of methanol is maintained by the Level Indicator in chemical receiver tank (9).
2. Add 1% Potassium Hydroxide Pellets (Koh) in the chemical receiver tank (9) And completely dissolve in chemical receiver tank (9), followed by circulation, Duration for 60 minutes, then discharge to the reactor (3) where the processed oil of phase I is present;
   Phase II Continued the process for 3 hours and maintained Temp. at 120 degree.
   Settling—Shut down the power and settling for 60 minutes, prior to separating glycerin, separating glycerin via gravity, After Glycerin Separated,
   Adding (Food Grade Phosphoric Acid concentrated 80-99%) 0.8% on total wt., where the processed oil of phase II is present in reactor (3); steering and circulation for 120 minutes. After completing of 120 minutes.
   settling—Shut down the power and settling for 60 minutes, prior to separating Soap Oil. so as to obtain a biodiesel (methyl ester) and glycerin and soap being separated out;

### Phase III:

A—Adding light liquid paraffin of 15 wt. % of total weight of biodiesel (methyl ester) of phase II, from the receiver tank (11) to the chemical receiver tank (12) and then to the reactor (10).
B—Adding TBHQ (TERT BUTYL HYDROQUINONE 0.035% of total weight of biodiesel (methyl ester) of phase II, to the reactor (10), where the processed oil of phase III (A) is present, steering in the reactor (10) at the rpm of 70 followed by circulation of 120 minutes.
Phase III (A&B) Continued the process for 2 hours and maintained Temp. at 90 Degrees. After completing the process A&B.
shifting the biodiesel (methyl ester) of phase II from reactor (3) to reactor (10); where the processed oil of phase III (A&B) is present, steering in the reactor (10) at the rpm of 70 followed by circulation of 120 minutes.
Process is completed.

Conclusion: We could not obtain biodiesel with 100% purity

### Example—4

Phase I, II & III experiments are performed in the following manners.
A. Heating Soya fatty at the temperature of 90 deg, to form a liquid.
B. discharging oil as a raw from the storage tank (1) in the reactor (3); Discharge the steam from the boiler (2) in the reactor (3) at the temperature of 110 Degrees.
C. vacuum discharge from the-pump (4) to receiver tank (5), from receiver tank (5) Through condenser (6) to the reactor (3), Vacuum at the pressure in the range of 750 mg/kg for 4 Hours.
D. Wherein the moisture contents (MC) is obtained less than 0.05%, after processing, steering in the reactor (3) at the rpm of 75 followed by circulation of oil through pump 2.5 hours followed by cooling from the cooling tower (7) in the reactor to reduce the temperature from about 110 to about 80 Degrees.
E. conducting-transesterification step in three phases:

### Phase 1:

1. discharging 15 wt. % methanol of total weight of oil in the reactor (3) from—the underground storage tank (8)—to the chemical receiver tank (9) wherein the exact quantity and accuracy of methanol is maintained by the Level Indicator in chemical receiver tank (9).
2. Adding 2% Sodium Methoxide (CH3NaO), in the chemical receiver tank (9) And completely dissolve in chemical receiver tank (9), followed by circulation, Duration for 60 minutes, then discharge—to the reactor (3). Phase 1 Continued the process for 4 hours and maintained temp. at 110.
   Settling—Shut down the power and settling for 60 minutes, Prior to separating glycerin, separating glycerin via gravity, so as to obtain a biodiesel (methyl ester) approximately with 70% of purity;

### Phase II:

discharging 4 wt. % methanol of total weight of oil in the reactor (3) from the underground storage tank (8) to the chemical receiver tank (9) wherein the exact quantity and accuracy of methanol is maintained by the Level Indicator in chemical receiver tank (9).
Adding 1% Sodium Methoxide (CH3NaO) in the chemical receiver tank (9) And completely dissolve in chemical receiver tank (9), followed by circulation, Duration for 60 minutes, then discharge to the reactor (3) where the processed oil of phase I is present;
Phase II Continued the process for 3 hours and maintained Temp. at 110 to 80 degree.
Settling—Shut down the power and settling for 60 minutes, prior to separating glycerin, separating glycerin via gravity, after glycerin Separated,
Adding (Food Grade Phosphoric Acid concentrated 80-99%) 0.5% on total wt., where the processed oil of phase II is present in reactor (3); steering and circulation for 120 minutes. After completing of 120 minutes.
settling—Shut down the power and settling for 60 minutes, prior to separating Soap Oil. so as to obtain a biodiesel (methyl ester) and glycerin and soap being separated out;

### Phase III:

A—Adding light liquid paraffin in the range of 20 wt. % of total weight of biodiesel (methyl ester) of phase II, from the receiver tank (11) to the chemical receiver tank (12) and then to the reactor (10).
B—Adding TBHQ (TERT BUTYL HYDROQUINONE) of 0.045% of total weight of biodiesel (methyl ester) of phase II, to the reactor (10), where the processed oil of phase III (A) is present, steering in the reactor (10) at the rpm of 70 followed by circulation of 120 minutes.
Phase III (A&B) continued the process for 2 hours and maintained Temp. at 110 Degrees. After completing the process, A&B.
shifting the biodiesel (methyl ester) of phase II from reactor (3) to reactor (10); where the processed oil of phase III (A&B) is present, steering in the reactor (10) at the rpm of 70 followed by circulation of 120 minutes.
Process is completed.

Conclusion: We obtained 100% pure biodiesel with the improved cold flow properties, however the emission control of CO2 and CO was not so good.

### Example—5

Phase I, II & III experiments are performed in the following manners.
a) discharging sunflower fatty oil as a raw from the storage tank (1) in the reactor (3) followed by discharging the steam from the boiler (2) in the reactor (3) at the temperature of 110 Degrees;
b) discharging vacuum from the-pump (4) to receiver tank (5) and then through condenser (6) to the reactor (3), at the pressure in the range of 750 mg/kg for about 2 Hours;
   wherein the moisture contents (MC) is obtained 0.04%, after processing, steering in the reactor (3) at the rpm of 75 followed by circulation of oil through Pump for 2 hours followed by cooling from the cooling tower (7) in the reactor to reduce the temperature from 110 to 70 Degrees;
C) conducting-transesterification step in three phases:

### Phase 1:

(i) discharging 15 wt. % methanol of total weight of oil in the reactor (3) from—the underground storage tank (8)—to the chemical receiver tank (9) wherein the exact quantity and accuracy of methanol is maintained by the Level Indicator in chemical receiver tank (9);
(ii) adding 1% Potassium Hydroxide Pellets (Koh) in the chemical receiver tank (9) and dissolving it completely in chemical receiver tank (9), followed by circulating it for about 45 minutes, and then discharging to the reactor (3); wherein phase 1 Continues the process for about 3.5 hours and maintained the temp. at 80 degree centigrade;
(iii) settling the mixture of reactor (3) for 45 minutes, prior to separating glycerin, wherein glycerin is separated via gravity, so as to obtain a biodiesel (methyl ester) approximately with 70% of purity;

### Phase II:

(i) discharging 5 wt. % of methanol of total weight of oil from the underground storage tank (8) to the chemical receiver tank (9) wherein the exact quantity and accuracy of methanol is maintained by the Level Indicator in chemical receiver tank (9);
(ii) adding 0.3% Potassium Hydroxide Pellets (Koh) in the chemical receiver tank (9) and dissolving it completely in chemical receiver tank (9), followed by circulating it for about 45 minutes, and then discharging to the reactor (3); where the processed oil of phase I is present; wherein phase 1 Continues the process for about 2.5 hours and maintained the temp. at 80 degree centigrade;
(iii) settling the mixture of reactor (3) for 45 minutes, prior to separating glycerin, wherein glycerin is separated via gravity;
(iv) adding 0.4% Food Grade Phosphoric Acid (concentrated 80-99%) on Total wt., where the processed oil of phase II is present in reactor (3) followed by steering and circulating it for about 90 minutes;
(v) settling the mixture of reactor (3) for 45 minutes, prior to separating Soap oil, wherein so as to obtain a biodiesel (methyl ester)

### Phase III:

(i) adding light liquid paraffin (LLP) in the range of 25 wt. % of total weight of biodiesel (methyl ester) of phase II, from the receiver tank (11) to the chemical receiver tank (12) and then to the reactor (10);
(ii) adding TBHQ (TERT BUTYL HYDROQUINONE) in the range of 0.35% of total weight of biodiesel (methyl ester) of phase II, to the reactor (10), where the processed oil of phase III (i) is present followed by steering in the reactor (10) at the rpm of 70 and circulating for about 90 minutes, wherein the phase III (i & ii) Continues the process for about 2 hours while maintaining the Temp. at 70 degrees;
(iii) shifting the biodiesel (methyl ester) of phase II from reactor (3) to reactor (10); where the processed oil of phase III (I & ii) is present followed by steering in the reactor (10) at the rpm of 60 and circulating for 120 minutes.

Conclusion: We obtained biodiesel approximately with 100% of purity with no residue of glycerin and soap. Also, cold flow properties and control of Emission achieved.

The below test report is shown the conclusion:

CUSTOMER DETAILS
Customer Name & Address:
Mr. MOHAMMED IDRIS AHMED,
6-54/15. Bank Colony Pothireddypally,
Sangareddy - 502295.
Customer Reference:
Test Requested Form dated on 27 Jun. 2022
Test Report No: TR2206131-01 Date: 08 Jul. 2022 Page 1 of 2
SAMPLE DETAILS

| | |
|---|---|
| Sampled by: CaRE Laboratory | Sampled on: 28 Jun. 2022 |
| Sample Code: 2206131-01 | Sampling Procedure: CaRE/QA/SOP/005 |
| Sample Name: BIODIESEL (B100) | Sample Received on: 28 Jun. 2022 |
| Sample Description: Stack Emission | Sample Completed on: 8 Jul. 2022 |

Identification by Customer

| | | | |
|---|---|---|---|
| DG Set | 500 | Location | CaRE Laboratory, |
| | | | Kelambakkam, Chennai |
| Identification | MULTI FEED STOCK | — | — |

Test Results

| | | | | |
|---|---|---|---|---|
| SI. No. | Test Parameter | Unit | Test Method | Results |

EXHAUST EMISSION PARAMETERS

| | | | | |
|---|---|---|---|---|
| 1 | Nitrogen as N2 | %/v/v | IS 5182 (Part 6): | 68 |
| | | | 2006 (Reaff: 2017) | |
| 2 | Oxygen as O2 | %/v/v | IS 13270: 1992 | 11 |
| | | | (Reaff: 2019) | |
| 3 | Carbon di-Oxide | %/v/v | IS 132700: 1992 | 2.96 |
| | as CO2 | | (Reaff 2019) | |
| 4 | Water Vapour as | %/v/v | IS 5182 (Part 6): | 3.0 |
| | H20 | | 2006 (Reaff: 2017) | |

REGULATED HARMFUL EMISSION PARAMETERS

| | | | | |
|---|---|---|---|---|
| 5 | Carbon | %/v/v | IS 13270: 1992 | BDL(DL:02) |
| | monoxide as CO | | (Reaff: 2019) | |
| 6 | Hydro carbon as | PPM | CPCB | 56 |
| | HC | | Guidelines | |
| | | | Volume-1 | |
| 7 | Nitrogen di- | PPM | IS 11255 (Part 7): | 30 |
| | oxide as NOx | | 1985 (Reaff: 2017) | |
| 8 | Sulphur di-oxide | PPM | IS 11255 (Part 2): | 30 |
| | as SOx | | 1985 (Reaff: 2019) | |
| 9 | Particulate | PPM | IS 11255 (Part 7): | 40 |
| | Matter - PM | | 1985 (Reaff: 2019) | |

Note: BDL—Below Detection Limit; DL—Detection Limit;

Test Report No: TR2206131-01 Date: 8 Jul. 2022 Page 2 of 2
SAMPLE DETAILS

| | |
|---|---|
| Sample Code: 2206131-01 | Sampled on: -- |
| Sample Name: FUEL | Sampled by: Customer |
| Sample Description: BIODIESEL | Sampling Procedure: -- |
| Identification by Customer: B100 MULTI | Sample Received on: 27 Jun. 2022 |
| FEED STOCK | |
| Test Started on: 28 Jun. 2022 | Sample Completed on: 8 Jul.2022 |

TEST RESULTS

| | | | | | Permissible |
|---|---|---|---|---|---|
| | Test | | | | Limits as |
| SI. NO. | Parameter | Test Method | Results | Unit | perASTM6751 |
| 1 | Viscosity | ASTMD445 | 4.4 | Cst | 3.5-5.0 |
| | @40 | | | | |
| 2 | Density @ 15 | ASTMD1298 | 0.873 | Kg/m2 | 0.860-0.900 |
| 3 | Flash point | ASTMD93 | 149 | ° C. | >100 |
| 4 | Calorific | Inhouse | 10080 | KJ/kg | >9500 |
| | value | Method | | | |
| | | (BombCalorie) | | | |
| 5 | Cetane | ASTMD613 | 57 | — | >51 |
| | number | | | | |
| 6 | Acid value | ASTMD664 | 0.35 | mgKOH/g | >0.8 |
| 7 | Cloud point | ASTMD2500 | −3 | ° C. | — |
| 8 | Pour Point | ASTMD97 | −2 | ° C. | — |
| 9 | Water content | ASTMD2709 | 0.5 | Mg/kg | <500 |
| 10 | Sulphur | ASTMD5453 | 1.1 | Mg/kg | Max. 10 |
| 11 | Total | EN12662 | 14 | Mg/kg | <20 |
| | contamination | | | | |
| 12 | Copper strip | ASTMD130 | No. 1 | Rating | Class 1 |
| | corrosion, 3 hr | | | | |
| | at 50 C. | | | | |
| 13 | Methanol | EN14110 | 0.01 | % by mass | <0.02 |
| | content | | | | |
| 14 | Oxidation | EN14112 | 6.4 | hr | >5 |
| | Stabilityat | | | | |
| | 110 C. | | | | |
| 15 | Iodine Value | ASTMD2274 | 44.3 | g/100 g | <120 |
| 16 | Phosphorous | ASTMD4951 | 0.6 | Mg/kg | <10 |
| | Content | | | | |
| 17 | Ester content | EN14103 | 98.7 | % by mass | >96.5 |
| 18 | Alkaline | EN14109 | 3.0 | Mg/kg | <5 |
| | matter (Na•K) | | | | |
| 19 | Alkaline | EN14538 | 3.0 | Mg/kg | <5 |
| | matter | | | | |
| | (Ca•Mg) | | | | |
| 20 | Cold Filter | EN116 | −5 | 0 | — |
| | Plugging | | | | |
| | Point (CFPP) | | | | |

*** End of Test Report ***

The above test was also compared with the biodiesel obtained from the Applicant's own Patent Application No. 201641014608 and found that the present biodiesel obtained from the disclosed process is much capable in reducing exhaust emission in vehicle. A test report for biodiesel of the Patent Application No. 201641014608 on exhaust emission is given below:

TEST REPORT
Customer Name & Address:
M/s PIK BIOFUELS PRIVATE LIMITED,
PLOT.NO.39, NEAR ROCK W001.,
MANDAL KOHIR, MEDAK DISTRICT-502321,
TELANGANA, INDIA.
Test Report: TR16030391B-01 Date: 12 Apr. 2016 Page 1 of 2
Customer Reference: Mail Confirmation on 9 Apr. 2016
SAMPLE DETAILS

| | |
|---|---|
| Sampled by: Client | Sampled on: 11 Apr. 2016 (14:05 Hrs to 15:05 |
| | Hrs) |
| Sample Code: 16030391B-01 | Sampling Procedure: IS 5182 Part V & XIV |
| Sample Name: Exhaust Emission | Sample Received on: 11 Apr. 2016 |
| Sample Description: Biodiesel-Animal | Sample Completed on: 12 Apr. 2016 |
| Tallow | |
| Temperature: 35.1 C. | Relative Humidity: 55% |

| | | | | |
|---|---|---|---|---|
| | | Method of | | |
| S.No | Description | Reference | Units | Results |

Exhaust Emission Components

| | | | | |
|---|---|---|---|---|
| 1. | Nitrogen as N2 | IS 5182 (Part- | % v/v | 71 |
| | | 6)2006(R 2012) | | |
| 2. | Oxygen as O2 | IS 13270: 1992 | % v/v | 11.2 |
| | | (Reaff. 2009) | | |
| 3. | Carbon di | IS 13270: 1992 | % v/V | 4.8 |
| | Oxide as Co2 | (Reaff. 2009) | | |
| 4. | H20 | IS 5182 (Part- | % v/v | 3.5 |
| | | 6)2006(R 2012) | | |

Regulated Harmful Components

| | | | | |
|---|---|---|---|---|
| 5. | Carbon | IS 13270: 1992 | % v/v | BDL (DL:02) |
| | monoxide as | (Reaff. 2009) | | |
| | CO | | | |
| 6. | Hydro carbons | CPCB | ppm | 58 |
| | as HC | Guidelines | | |
| | | Volume-1 | | |
| 7. | Nitrogen di- | IS 11255 (Part- | ppm | 36 |
| | oxide as NOx | 7)2005(Reaff. | | |
| | | 2012) | | |
| 8. | Sulphur di- | IS 11255 (Part- | ppm | 32 |
| | oxide as SOx | 2) 1985 (Reaff. | | |
| | | 2009) | | |
| 9. | Particulate | IS 11255 (Part- | ppm | 45 |
| | Matter - PM | 1): 1985 (Reaff. | | |
| | | 2009) | | |

*** Contd ***
Test Report: TR16030391B-01 Date: 12 Apr. 2016 Page 2 of 2
Unregulated Harmful Components

| | | | | |
|---|---|---|---|---|
| 10. | Ammonia | CPCB | Mg/km | 1.17 |
| | | Guidelines | | |
| | | Volume-1 | | |
| 11. | Cyanides | CPCB | Mg/km | 0.620 |
| | | Guidelines | | |
| | | Volume-1 | | |
| 12. | Benzene as | IS 5182 (Part | Mg/km | 3.70 |
| | C6H6 | 11) 2006 (R | | |
| | | 2012) | | |
| 13. | Toluene | IS 5182 (Part | Mg/km | 1.20 |
| | | 11) 2006 (R | | |
| | | 2012) | | |
| 14. | Aldehydes | CPCB | Mg/km | 0.0 |
| | | Guidelines | | |
| | | Volume-1 | | |

Note: BDL—Below Detection Limit; DL—Detection Limit
*** End of Test Report ***

### Example—6

Phase I, II & III experiments are performed in the following manners.
d) discharging palm fatty oil as a raw from the storage tank (1) in the reactor (3) followed by discharging the steam from the boiler (2) in the reactor (3) at the temperature of 110 Degrees;
e) discharging vacuum from the-pump (4) to receiver tank (5) and then through condenser (6) to the reactor (3), at the pressure in the range of 750 mg/kg for about 2 Hours;
wherein the moisture contents (MC) is obtained 0.04%, after processing, steering in the reactor (3) at the rpm of 75 followed by circulation of oil through Pump for 2 hours followed by cooling from the cooling tower (7) in the reactor to reduce the temperature from 110 to 70 Degrees;
f) conducting-transesterification step in three phases:

### Phase 1:

(i) discharging 15 wt. % methanol of total weight of oil in the reactor (3) from—the underground storage tank (8)—to the chemical receiver tank (9) wherein the exact quantity and accuracy of methanol is maintained by the Level Indicator in chemical receiver tank (9);
(ii) adding 1.5% Sodium Methoxide (CH3NaO) in the chemical receiver tank (9) and dissolving it completely in chemical receiver tank (9), followed by circulating it for about 45 minutes, and then discharging to the reactor (3); wherein phase 1 Continues the process for about 3.5 hours and maintained the temp. at 70 degree centigrade;
(iii) settling the mixture of reactor (3) for 45 minutes, prior to separating glycerin, wherein glycerin is separated via gravity, so as to obtain a biodiesel (methyl ester) approximately with 70% of purity;

### Phase II:

(iv) discharging 5 wt. % of methanol of total weight of oil from the underground storage tank (8) to the chemical receiver tank (9) wherein the exact quantity and accuracy of methanol is maintained by the Level Indicator in chemical receiver tank (9);
(v) adding 0.35% Sodium Methoxide (CH3NaO) in the chemical receiver tank (9) and dissolving it completely in chemical receiver tank (9), followed by circulating it for about 45 minutes, and then discharging to the reactor (3); where the processed oil of phase I is present; wherein phase 1 Continues the process for about 2.5 hours and maintained the temp. at 70 degree centigrade;
(vi) settling the mixture of reactor (3) for 45 minutes, prior to separating glycerin, wherein glycerin is separated via gravity;
(iv) adding 0.4% Food Grade Phosphoric Acid (concentrated 80-99%) on Total wt., where the processed oil of phase II is present in reactor (3) followed by steering and circulating it for 90 minutes;
(v) settling the mixture of reactor (3) for 45 minutes, prior to separating Soap oil, wherein so as to obtain a biodiesel (methyl ester)

### Phase III:

(iv) adding light liquid paraffin (LLP) in the range of 25 wt. % of total weight of biodiesel (methyl ester) of phase II, from the receiver tank (11) to the chemical receiver tank (12) and then to the reactor (10);
(v) adding TBHQ (TERT BUTYL HYDROQUINONE) in the range of 0.35% of total weight of biodiesel (methyl ester) of phase II, to the reactor (10), where the processed oil of phase III (i) is present followed by steering in the reactor (10) at the rpm of 70 and circulating for about 90 minutes, wherein the phase III (i & ii) Continues the process for 2 hours while maintaining the Temp. at 65 degrees;
(vi) shifting the biodiesel (methyl ester) of phase II from reactor (3) to reactor (10); where the processed oil of phase III (I & ii) is present followed by steering in the reactor (10) at the rpm of and circulating for 120 minutes.

Conclusion: We obtained biodiesel approximately with 100% of purity with no residue of glycerin and soap. Also, cold flow properties and control of Emission is achieved with almost same result as above.

The same experiments of Examples 5 and 6 were performed with other fatty oils such as jatropa oil, soyabean oil, tallow oil, used cooking oil and its combination, however we achieved almost same result as concluded in Example 5.

### Advantages of the Present Invention

The main advantages of the present invention are:
1) Present invention provides with cost effective biodiesel (methyl ester) prepared from the any of the vegetable or animal oil, even the used cooking oil which is easily available.
2) Present invention provides with high quality biodiesel (methyl ester) which can directly be used as a fuel without blended with any other petroleum diesel.
3) Present invention provides biodiesel (methyl ester) with reduced exhaust emission in vehicle and improved cold flow properties.
4) Present invention provides biodiesel (methyl ester) with reduced exhaust emission components and increase the level of oxygen in environment.
5) Present invention provides biodiesel (methyl ester) with reduced harmful components.

What is claimed is:

1. A process for preparing biodiesel (Methyl Ester) from vegetable or non-vegetable oil (animal oil) and/or its combination thereof, wherein the method comprising the steps of:
a) discharging oil as a raw from the storage tank (1) in the reactor (3) followed by discharging the steam from the boiler (2) in the reactor (3) at the temperature of 30 to 110 degrees;
b) discharging vacuum from the-pump (4) to receiver tank (5) and then through condenser (6) to the reactor (3), at the pressure in the range of 150 to 750 mg/kg for about 0 to 3 Hours;
wherein the moisture contents (MC) is obtained less than 0.01 to 0.05%, after processing, steering in the reactor (3) at the rpm of 60 to 75 followed by circulation of oil Through Pump about 0-2.5 hours followed by cooling from the cooling tower (7) in the reactor to reduce the temperature from about 110 to about 70 Degrees;
c) conducting-transesterification step in three phases:
Phase 1:
(i) discharging 10-16 wt. % methanol of total weight of oil in the reactor (3) from—the underground storage tank (8)—to the chemical receiver tank (9) wherein the exact quantity and accuracy of methanol is maintained by the Level Indicator in chemical receiver tank (9);
(ii) adding 0.7-1.5% Potassium Hydroxide Pellets (Koh) or 1-4% Sodium Methoxide (CH3NaO) in the chemical receiver tank (9) and dissolving it completely in chemical receiver tank (9), followed by circulating it for about 0-60 minutes, and then discharging to the reactor (3); wherein phase 1 Continues the process for about 0-4 hours and maintained the temp. at 80 to 70 degrees centigrade;
(iii) settling the mixture of reactor (3) for 0-60 minutes, prior to separating glycerin, wherein glycerin is separated via gravity, so as to obtain a biodiesel (methyl ester) approximately with 70% of purity;
Phase II:
(i) discharging 3-6 wt. % of methanol of total weight of oil from the underground storage tank (8) to the chemical receiver tank (9) wherein the exact quantity and accuracy of methanol is maintained by the Level Indicator in chemical receiver tank (9);
(ii) adding 0.1-0.5% Potassium Hydroxide Pellets (Koh) or 0.1-1% Sodium Methoxide (CH3NaO) in the chemical receiver tank (9) and dissolving it completely in chemical receiver tank (9), followed by circulating it for about 0-60 minutes, and then discharging to the reactor (3); where the processed oil of phase I is present; wherein phase 1 Continues the process for about 0-4 hours and maintained the temp. at 80 to 70 degree centigrade;
(iii) settling the mixture of reactor (3) for 0-60 minutes, prior to separating glycerin, wherein glycerin is separated via gravity;
(iv) adding 0.1-0.8% Food Grade Phosphoric Acid (concentrated 80-99%) on Total wt., where the processed oil of phase II is present in reactor (3) followed by steering and circulating it for about 0-120 minutes;
(v) settling the mixture of reactor (3) for 0-60 minutes, prior to separating Soap oil, wherein so as to obtain a biodiesel (methyl ester) approximately with 100% of purity with no residue of glycerin and soap;
Phase III:
(i) adding light liquid paraffin (LLP) in the range of 1-25 wt. % of total weight of biodiesel (methyl ester) of phase II, from the receiver tank (11) to the chemical receiver tank (12) and then to the reactor (10);
(ii) adding TBHQ (TERT BUTYL HYDROQUINONE) in the range of 0.1% to 0.5% of total weight of biodiesel (methyl ester) of phase II, to the reactor (10), where the processed oil of phase III (i) is present followed by steering in the reactor (10) at the rpm of 60 to 70 and circulating for about 0-120 minutes, wherein the phase III (i & ii) Continues the process for about 0-2 hours while maintaining the Temp. at 70 to about 65 Degrees;
(iii) shifting the biodiesel (methyl ester) of phase II from reactor (3) to reactor (10); where the processed oil of phase III (I & ii) is present followed by steering in the reactor (10) at the rpm of 60 to 70 and circulating for about 0-120 minutes;
(iii) draining the biodiesel (Methyl Ester) from reactor (10) to leaf filter, wherein filter mesh is 1-3 microns, followed by discharging the filtered biodiesel B100 into storage tank (13) with 100% purity.

2. The process as claimed in claim 1, wherein the vegetable oil is selected from the group comprising Soya oil, Palm oil, Palm Stearin, Used Cooking Oil, Jatropha oil, Tallow and Sunflower oil etc.

3. The process as claimed in claim 1, wherein the weight ratio of methanol to the oil in the phase I is used approximately in the range of 1:0.10-1:0.16.

4. The process as claimed in claim 1, wherein the weight ratio of methanol to the oil in the phase II is used in the range of 1:0.03-1:0.06.

5. The process as claimed in claim 1, wherein the weight ratio of Potassium Hydroxide to the oil in the phase I is used approximately in the range of 1:0.007-1:0.015.

6. The process as claimed in claim 1, wherein the weight ratio of Sodium Methoxide to the oil in the phase I is used approximately in the range of 1:0.01-1:0.04.

7. The process as claimed in claim 1, wherein weight ratio of Potassium Hydroxide to the oil in the phase II is in the range of 1:0.001-1:0.005.

8. The process as claimed in claim 1, wherein the weight ratio of Sodium Methoxide to the oil in the phase II is used in the range of 1:0.001-1:0.01.

9. The process as claimed in claim 1, the weight ratio of Light Liquid paraffin oil to the biodiesel (methyl ester) of phase III is used in the range of 1:0.01-1:0.25.

10. The process as claimed in claim 1, wherein the weight ratio of TERT BUTYL HYDROQUINONE to the biodiesel (methyl ester) of phase III is used in the range of 1:0.001-1:0.005.
